(19) United States
(12) Patent Application Publication
(10) Pub. No.: US 2008/0282737 A1
(43) Pub. Date: Nov. 20, 2008

(54) PRESS-MOLDING APPARATUS

(75) Inventor: Satoshi OHGAMI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/176,061

(22) Filed: Jul. 18, 2008

Related U.S. Application Data
(63) Continuation of application No. PCT/JP07/50727, filed on Jan. 18, 2007.

(30) Foreign Application Priority Data
Jan. 19, 2006 (JP) 2006-010671

(51) Int. Cl. C03B 11/00

(52) U.S. Cl. 65/157

(57) ABSTRACT

The invention provides a press-molding apparatus having, disposed on a conveying passageway: a heating chamber for heating a mold containing a raw material placed therein; a molding chamber for press-molding the raw material in a non-oxidizing gas atmosphere; and a cooling chamber for cooling the mold after the molding, the mold being conveyed on the conveying passageway in order, each of the heating chamber, the molding chamber, and the cooling chamber being blocked from the atmosphere upon the press-molding, the press-molding apparatus having: a means for blocking the molding chamber and the cooling chamber; and an inflow port for introducing the non-oxidizing gas into the press-molding apparatus, the inflow port being formed for at least one of the heating chamber and the molding chamber.

### TECHNICAL FIELD

The present invention relates to a press-molding apparatus for press-molding optical elements, e.g., glass lenses for use in optical instruments.

### BACKGROUND ART

A molding method has hitherto been practiced extensively in which a raw glass material which has been heated and softened is press-molded to produce an optical element comprising a glass lens. Namely, for example, a raw glass material preformed into a spherical shape is set in a mold constituted of an upper die, lower die, and barrel die, softened by heating to about 500-800° C. in a heating step, and then pressed and molded into a lens product and this product is cooled and then taken out.

Of those steps, the molding, in particular, is conducted at a high temperature. Because of this, in case where the molding is conducted in air, which contains oxygen, oxidation of the mold and mold-protective film proceeds, resulting in a shortened mold life. In particular, the molding surfaces of molds for use in forming the optical surfaces of lenses are high-precision mirror surfaces. These molding surfaces, upon oxidation, become rough and impair the transmission and shape accuracy of the lens to be molded, thereby influencing the performance of the lens. Furthermore, there are cases where the mold surfaces or the surface of the raw glass material reacts with the oxygen in air to form oxides, and these oxides react with each other during press molding and adhere tenaciously, resulting in a trouble that the molded article cannot be removed from the mold. When such a molded article which has adhered to the mold is forcibly removed, part of the raw glass material remains in the mold and the molded article does not satisfy lens quality. In addition, the residue adheres to the raw glass material to be molded thereafter and influences lens quality. For removing the residue without marring the mirror surface of the mold, it is necessary to conduct a treatment which, for example, comprises conducting polishing with an alumina powder or dissolving the glass in a solution of hydrofluoric acid, ammonium fluoride, or the like. In case where the mold is marred accidentally in this treatment, the molding surface should be subjected to coating or processing again and this necessitates much labor and cost. Furthermore, in case where the mold has oxidized, the sliding parts of the upper die and barrel die have increased resistance and this results in a prolonged molding tact and the necessity of modifying the molding conditions. Stable mass-production hence becomes impossible.

For avoiding such troubles, it is necessary to fill the molding apparatus with a non-oxidizing gas such as, e.g., nitrogen gas or argon gas and maintain a non-oxidizing atmosphere in which oxygen does not come. Especially in the molding step, in which press molding is conducted at a high temperature, it is important to maintain a low oxygen concentration to prevent the mold and the raw material from oxidizing. On the other hand, it is also important to reduce the amount of the non-oxidizing gas to be used, because it is expensive. Consequently, such a non-oxidizing gas is necessary especially in the molding chamber and it is desirable that the gas should be efficiently supplied to the molding apparatus according to the amount of the gas required for each chamber in the molding apparatus to thereby save gas consumption amount.

Hitherto, a technique has been used in which a molding apparatus is wholly evacuated and then filled with a non-oxidizing gas to keep the apparatus at a positive pressure so as to prevent oxygen from coming into the apparatus and shutters are disposed at the inlet and outlet of the whole molding apparatus or of each step part to block from the atmosphere.

Patent document 1 discloses a molding machine having shutters disposed between steps and in which conveyance between the steps is conducted with a conveyor or a turntable. However, in the case of conducting conveyor conveyance, the opening/closing device such as a shutter should be prevented from coming into contact with the belt. In the case of conveyance with a turntable, the rotating part should be prevented from coming into contact with stationary parts. Consequently, in either case, the gas tightness of each step chamber cannot be sufficiently maintained. For reducing the oxygen concentration in the molding chamber, it is therefore necessary to reduce the oxygen concentration in the whole molding machine. For attaining this, a large amount of a non-oxidizing gas should be introduced into the molding machine. This results in an increased cost. In addition, since heating and cooling in this molding machine are conducted while moving a mold, the heating chamber and the cooling chamber are large and a non-oxidizing gas for reducing oxygen concentration is necessary in a large amount. Furthermore, externally introducing a large amount of a non-oxidizing gas into the molding machine impairs the heat efficiency in the molding machine. Moreover, since a temperature gradient occurs in the heating chamber and the cooling chamber, it is difficult to conduct stable temperature control for obtaining a precise molded article, resulting in an increased installation cost.

Patent document 2 discloses a molding apparatus in which a rotating rod is used to convey a mold to a heating part, molding part, and cooling part successively. In this molding apparatus, since a mold is conveyed with one rotating rod, a space for enabling the rotating rod to pass therethrough is necessary in each chamber for conveyance over a distance corresponding to a mold interval. For reducing the oxygen concentration in the molding chamber in this molding apparatus, it is necessary to dispose a chamber which covers all the chambers and to introduce a non-oxidizing gas into this chamber. Consequently, a large amount of a non-oxidizing gas is necessary and this results in an increased cost. Furthermore, the gas tightness of each chamber cannot be sufficiently maintained and heat transfer occurs in an increased amount, resulting in an impaired thermal efficiency and difficulties in precisely controlling the temperature of each chamber.

FIG. 5 shows an example of a related-art molding machine 51 disclosed, e.g., in patent document 2. A mold 11 is conveyed with a conveying rod 54 having conveying arms 55 through step chambers separated by shielding plates 52.

By the rotation of the conveying rod 54 in the direction of arrow A, the conveying arms 55 are disposed after molds 11 in the step chambers. After the vertically movable shielding plates 52 have opened, the conveying rod 54 moves slidably in the conveyance direction and the conveying arms 55 push and convey the molds 11. In order that a mold 11 might be conveyed to the next step chamber with a conveying arm 55, the partition wall between the step chambers should have a gap 53 for passing the conveying arm 55 therethrough. Because of the formation of this gap 53, it is necessary to keep the whole molding machine 51 in a non-oxidizing atmosphere for reducing the oxygen concentration in the molding chamber. For attaining this, a chamber which covers the whole molding machine 51 is separately necessary and a non-oxidizing gas should be introduced into this chamber. Consequently, a large amount of a non-oxidizing gas is necessary, resulting in an increased cost. Furthermore, since heat in each step chamber escapes through the gap 53, the heat efficiency is poor and precise temperature control for every step chamber is difficult.

### [Patent Document 1] JP-B-1-46451

### [Patent Document 2] JP-B-3-55417

### DISCLOSURE OF THE INVENTION

### Problems to be Resolved by the Invention

The invention has been achieved in view of the prior-art techniques described above. An object of the invention is to provide a press-molding apparatus in which the oxygen concentration in a molding chamber can be efficiently reduced with a small amount of a non-oxidizing gas and the molding of precise optical elements can be stably conducted.

### Means of Solving the Problems

The invention provides, in a first aspect thereof, a press-molding apparatus comprising, disposed on a conveying passageway: a heating chamber for heating a mold containing a raw material placed therein; a molding chamber for press-molding the raw material in a non-oxidizing gas atmosphere; and a cooling chamber for cooling the mold after the molding, the mold being conveyed on the conveying passageway in order, each of the heating chamber, the molding chamber, and the cooling chamber being blocked from the atmosphere upon the press-molding, the press-molding apparatus comprising: a means for blocking the molding chamber and the cooling chamber; and an inflow port for introducing the non-oxidizing gas into the press-molding apparatus, the inflow port being formed for at least one of the heating chamber and the molding chamber.

In a second aspect of the invention, the press-molding apparatus preferably has a means for blocking the heating chamber and the molding chamber, and the non-oxidizing gas inflow port is formed for the molding chamber.

In a third aspect of the invention, in the press-molding apparatus indicated above, the cooling chamber is preferably blocked from the atmosphere with an opening/closing device attaining high gas tightness.

In a fourth aspect of the invention, in the press-molding apparatus indicated above, the means for blocking the molding chamber and the cooling chamber preferably comprises either of: an opening/closing device capable of regulating gas tightness; and a partition wall having a hole whose degree of opening can be regulated.

In a fifth aspect of the invention, in the press-molding apparatus indicated above, the means for blocking the heating chamber and the molding chamber preferably comprises either of: an opening/closing device capable of regulating gas tightness; and a partition wall having a hole whose degree of opening can be regulated.

In a sixth aspect of the invention, in the press-molding apparatus indicated above, the non-oxidizing gas is preferably introduced through the inflow port after having passed through a dust collection filter of 50 μm or finer.

In a seventh aspect of the invention, in the press-molding apparatus indicated above, the non-oxidizing gas is preferably introduced through the inflow port after having been heated to 50° C. or higher.

### ADVANTAGEOUS EFFECTS OF THE INVENTION

According to the first aspect of the invention, due to the formation of a non-oxidizing-gas inflow port for either of the heating chamber and the molding chamber, the introduction of a non-oxidizing gas can be concentrated on the heating chamber and molding chamber, which have a high temperature and are most required to retain a low oxygen concentration, whereby the oxygen concentration can be sufficiently reduced. Consequently, the qualities of the raw material and molded article can be maintained and the mold can be prevented from deteriorating, whereby precise molded articles can be stably produced. Furthermore, the mold and the mold-protective film have a prolonged life and the frequency of maintenance is reduced. Therefore, costs including mold cost and labor cost can be reduced.

According to the second aspect of the invention, by concentrating the introduction of a non-oxidizing gas on the molding chamber, the oxygen concentration in the molding chamber can be efficiently reduced with a smaller amount of the non-oxidizing gas.

According to the third aspect of the invention, the non-oxidizing gas can be prevented from leaking from the cooling chamber to the outside and oxygen can be inhibited from flowing in from the outside. Because of this, a non-oxidizing gas can be utilized, without being wasted, to reduce the oxygen concentration in the molding apparatus. Incidentally, the term “having high gas tightness” in the invention means that the pressure loss resulting from leakage is 30 hPa or higher.

According to the fourth aspect of the invention, a non-oxidizing gas is introduced preferentially into the heating chamber and the molding chamber to reduce the oxygen concentration therein, and gas tightness or the degree of opening between the molding chamber and the cooling chamber is regulated. Thus, the non-oxidizing gas can be caused to flow also into the cooling chamber from the molding chamber in a desired proportion according to the properties of the molded article, etc. Since this gas introduction from the molding chamber is based on leakage of the gas to the cooling chamber, the amount necessary for each chamber can be satisfied with a small amount of the non-oxidizing gas.

According to the fifth aspect of the invention, a non-oxidizing gas is introduced preferentially into the molding chamber and gas tightness or the degree of opening between the heating chamber and the molding chamber is regulated. Thus, the non-oxidizing gas can be caused to flow in a desired amount into the heating chamber by utilizing the gas which leaks from the molding chamber. Consequently, a non-oxidizing gas can be used in a smaller amount to cause the non-oxidizing gas to flow into both the molding chamber and the heating chamber, which are heated to a high temperature, and thereby reduce the oxygen concentration.

According to the sixth aspect of the invention, dust is inhibited from flowing into the molding apparatus and, in particular, foreign substances having a particle diameter larger than 50 μm, which exert an influence on lens performances, are prevented from adhering to the mold and the raw material. Thus, the quality of the molded article can be maintained. Incidentally, the term “dust collection filer of 50 μm” in the invention means a dust collection filter which allows substantially no particles having a particle diameter larger than 50 μm to pass therethrough.

According to the seventh aspect of the invention, a non-oxidizing gas which has been heated is introduced, whereby the inside of the molding chamber is prevented from being rapidly cooled and the temperature distribution around the mold is prevented from rapidly changing. Thus, molding accuracy is prevented from being impaired.

### BRIEF DESCRIPTION OF THE DRAWINGS

FIG. 1 contains vertical sectional views showing an embodiment of the invention

FIG. 2 is an enlarged sectional view showing the internal structure of the wall surface in FIG. 1

FIG. 3 is a piping diagram of the non-oxidizing gas for use in FIG. 1

FIG. 4 contains plan views showing a conveyance procedure according to the invention

FIG. 5 is a perspective view showing a related-art example

### DESCRIPTION OF THE REFERENCE NUMERALS AND SIGNS

1: conveying apparatus
2: conveying passageway
4a, 4b: radiating plate
5: cylinder
6: supply pipe
7: pressing rod
8: mold supply device
10: chamber
11: mold
12: raw material
13: molded article
14: heater
15: cooling water piping
16: gas piping
20: wall surface
21: preliminary chamber
22: heating chamber
23: molding chamber
24: cooling chamber
25: mold placement surface
26a, 26b: conveying rod
27a, 27b: conveying arm
28: positioner
29: stopper
31, 32, 33, 34: shutter
41: non-oxidizing gas supply source
42a: filter
51: molding machine
52: shielding plate
53: gap
54; conveying rod
55: conveying arm

### BEST MODE FOR CARRYING OUT THE INVENTION

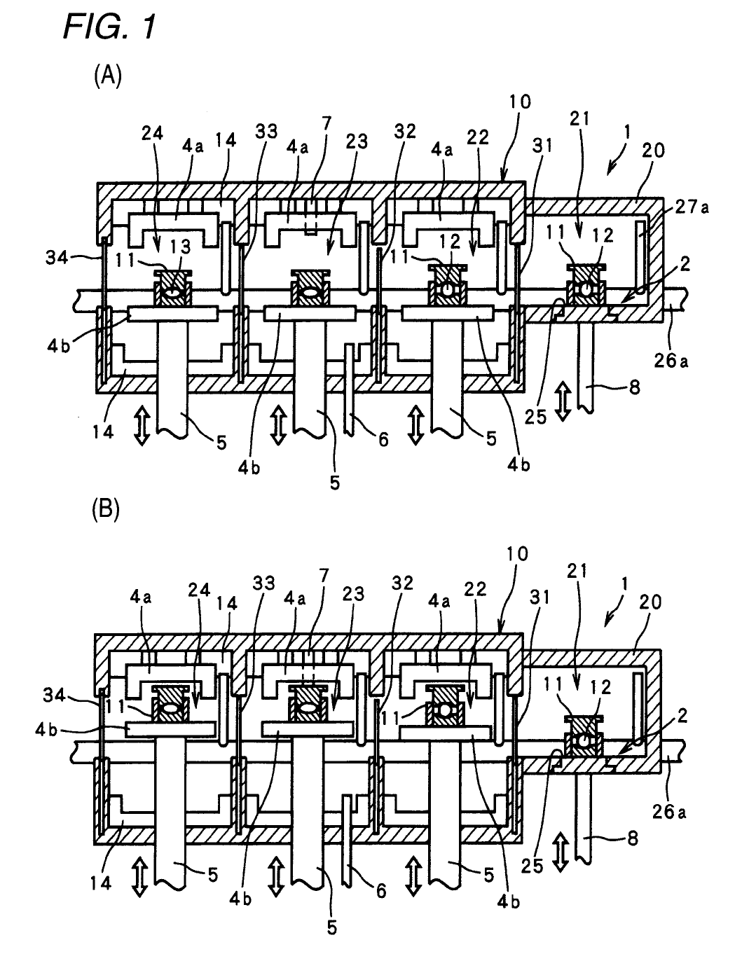

FIG. 1 shows vertical sectional views of an embodiment of the invention. In FIG. 1, (A) shows the positions of molds during mold conveyance, and (B) shows the positions of molds in practicing the steps.

The molding apparatus 1 has a conveying passageway 2 which is disposed in a chamber 10 made to retain a non-oxidizing atmosphere, e.g., a nitrogen atmosphere, and through which molds 11 are conveyed from the right to the left in the figure. A preliminary chamber 21, a heating chamber 22, a molding chamber 23, and a cooling chamber 24 are disposed in this order from the right side in the figure on a straight line along the conveying passageway 2.

The chambers each have a shutter 31, 32, or 33 at the boundary between it and the adjoining chamber, and a shutter 34 serving as the outlet of the chamber 10 is disposed after (left side of) the cooling chamber 24. The shutters 31, 32, 33, and 34 are vertically moved and opened/closed by, e.g., an air cylinder (not shown in the figure). The shutter 34 disposed after the cooling chamber 24 fits into a groove or the like and gas-tightly closes without leaving a gap so that the shutter 34 in the closed state completely blocks the chamber from the outside. The shutters 31, 32, and 33, which are disposed at the boundaries between adjoining chambers, can be independently regulated with respect to gas tightness. For regulating gas tightness, a method can be used in which the degree of opening of each shutter, i.e., the size of the gap to be formed over the upper end of each of the shutters 31, 32, and 33, is regulated as shown in, e.g., FIG. 1. In FIG. 1, the apparatus is in such a state that the shutter 32 between the molding chamber 23 and the heating chamber 22 has a slightly high degree of opening so that the gas in the molding chamber 23 is apt to flow into the heating chamber 22 and the other shutters 31 and 33 have a low degree of opening so that the gas discharged from the molding chamber 23 and the heating chamber 22 can flow in a small amount into the preliminary chamber 21 and the cooling chamber 24. Such regulation of gas tightness is accomplished by measuring the degrees of opening of the shutters 31, 32, and 33 and the oxygen concentrations in the chambers 22, 23, and 24 beforehand and determining the degrees of shutter opening which result in a desired oxygen concentration distribution. In case where the shutters deform thermally, gas tightness is impaired and oxygen concentration regulation becomes difficult. It is therefore preferred to use a metal having a low coefficient of thermal expansion or a ceramic as the material of the shutters. Gas tightness regulations may be conducted also by forming a hole in the shutters or the wall surface and regulating the degree of opening of the hole.

The heating chamber 22, molding chamber 23, and cooling chamber 24 each are provided with radiating plates 4a and 4b respectively over and under the mold 11. The lower radiating plate 4b is used as a table for placing the mold 11 thereon. The radiating plates 4a and 4b are disposed slightly apart from the shutters 31, 32, and 33 so as not to be thermally influenced by the adjoining chambers.

During mold conveyance, those upper surfaces of the radiating plates 4b on which the respective molds 11 are placed are on the same level as the mold placement surface 25 of the preliminary chamber 21 as shown in (A).

Heaters 14 are disposed along the inner wall surfaces of the heating chamber 22, molding chamber 23, and cooling chamber 24, and the temperatures in the chambers are independently regulated. The radiating plates 4a and 4b are heated to a suitable temperature by contact with the heaters 14 or by means of the radiant heat emitted by the heaters 14, and transfer the heat to the molds 11. In FIG. 1, the upper radiating plates 4a are heated by contact with heaters 14, while the lower radiating plates 4b are heated by the radiant heat emitted by heaters 14. Incidentally, a heater may be embedded in the radiating plates 4a and 4b to heat them. The cooling chamber 24 may be provided with a cooling pipe or the like in place of or besides the heaters 14.

The lower radiating plate 4b in each of the chambers 22, 23, and 24 is attached to a vertically movable cylinder 5, and moves the mold 11 upward in practicing the step, as shown in (B). In the molding chamber 23, the mold 11 is pressed with a pressing rod 7. Incidentally, a cylinder may be disposed on the pressing rod 7 side so that press molding can be conducted when the mold 11 is in the position shown in (A).

A supply pipe 6 for introducing a non-oxidizing gas (hereinafter sometimes referred to as “inflow port”) is disposed which extends from the outside of the chamber 10 and is connected to the inside of the molding chamber 23. Through this supply pipe 6, a non-oxidizing gas, e.g., nitrogen or argon gas, is externally introduced into the molding chamber 23. Incidentally, the non-oxidizing gas or the like introduced is discharged when the shutters are open or through minute gaps between sliding members of the cylinder, etc.

The non-oxidizing gas is supplied after having been heated to 50° C. or higher.

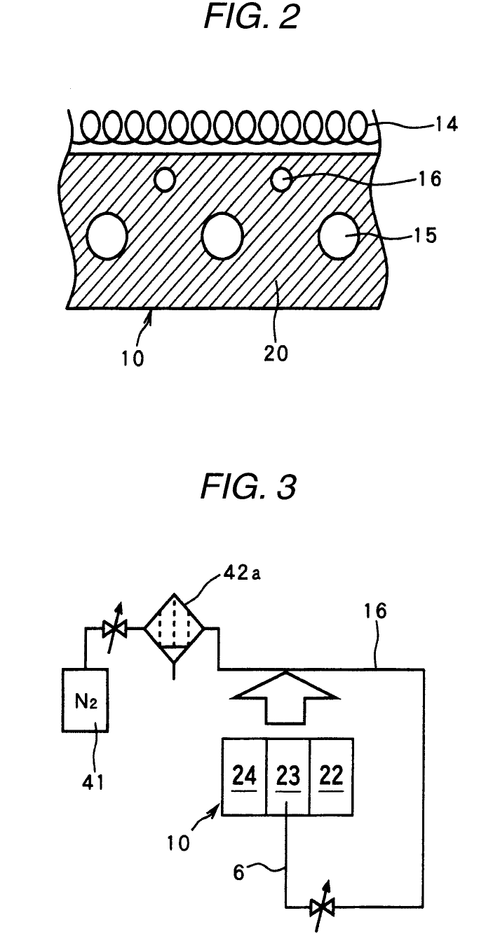

FIG. 2 is an enlarged sectional view showing an inner part of the wall surface 20 of the chamber 10. A cooling water piping 15 for cooling the heat transferred from the inside of the chamber 10 is disposed in an outer part of the wall surface 20. A gas piping 16 is disposed on the inner side of the cooling water piping 15, and a non-oxidizing gas is caused to flow through the gas piping 16. Thus, the non-oxidizing gas can be warmed using the heat of the inside of the chamber 10 and the amount of cooling water can be reduced. Incidentally, a gas supply pipe 16 and a cooling water piping 15 may be disposed on the outer surface of the wall of the chamber 10. Furthermore, the non-oxidizing gas is introduced after dust has been removed therefrom by passing the gas through a dust collection filter.

FIG. 3 is a piping diagram of a non-oxidizing gas, e.g., nitrogen gas. Nitrogen gas sent from a non-oxidizing gas supply source 41 passes through a filter 42a, subsequently passes through the gas piping 16 shown in FIG. 2 described above, and is warmed by the heat of the inside of the chamber 10. The gas heated is introduced through the supply pipe 6 into the molding chamber 23 in the chamber 10. Usually, inclusion of dust particles having a particle diameter of 50 μm or larger into the molding chamber 23 reduces lens quality and makes it impossible to obtain given performances. Consequently, the filter 42a to be used is one having a dust collection performance of 50 μm or finer. Incidentally, the term “having a dust collection performance of 50 μm” means to have a performance by which the filter substantially blocks particles having a particle diameter larger than 50 μm. The proportion of particles passing through the filter in particles having a particle diameter larger than 50 μm is preferably lower than 5% by mass, more preferably lower than 0.5% by mass. As the filter 42a is used a filter of the air washer type or a filter comprising a filter medium. Furthermore, the non-oxidizing gas to be used, e.g., nitrogen gas, is one having an oxygen concentration of 10-20 ppm or lower. This is because as the oxygen concentration of the non-oxidizing gas increases to 100 ppm or higher, the life of the molds abruptly becomes short and the yield of molded articles also decreases.

As a result of the introduction of such a non-oxidizing gas into the molding chamber 23, the molding chamber 23, which requires the non-oxidizing gas in a largest amount, has a lowest oxygen concentration. The non-oxidizing gas flows into the preliminary chamber 21, heating chamber 22, and cooling chamber 24 in given amounts through, e.g., gaps of the shutters 31, 32, and 33. Thus, the oxygen concentration in each chamber is suitably reduced and an appropriate oxygen concentration distribution is obtained. Furthermore, due to the introduction of the non-oxidizing gas into the chamber 10, the inside of the chamber 10 has a positive pressure relative to the outside, and air is less apt to flow thereinto from the outside.

A procedure of molding with this molding apparatus 1 is explained below by reference to FIG. 1.

A raw optical-glass material 12 and a molded article 13 are sent, in the state of being placed in a mold 11, to the chamber where each step is conducted.

First, a mold 11 containing the raw material 12 set therein is supplied to the preliminary chamber 21 with a mold supply device 8. A non-oxidizing gas is flowing into the preliminary chamber 21 from the molding chamber 23 through gaps of the shutters 32 and 31. Because of this, the oxygen concentration in the mold 11 can be reduced by allowing the mold 11 to stand in the preliminary chamber 21 for a given time period. After the given time period has passed and the gas in the mold 11 has been replaced, the shutter 31 is opened and the mold 11 is conveyed to the adjoining heating chamber 22 with the conveying means which will be described later.

After the mold 11 is placed in a given position in the heating chamber 22, the cylinder 5 is elevated to the position shown in (B) of FIG. 1 to bring the mold 11 near to or into contact with the upper radiating plate 4a and heat it to a temperature at which the raw glass material 12 softens and can be press-molded, i.e., to the glass transition point (Tg) or higher. After completion of the heating step, the cylinder 5 is lowered to return the mold to the position shown in (A) of FIG. 1. The shutter 32 is opened and the mold 11 is conveyed to the adjoining chamber.

After the mold 11 is placed in a given position in the molding chamber 23, the cylinder 5 is elevated again to bring the mold 11 near to the upper radiating plate 4a. While continuing the heating until the temperature of the raw material 12 reaches a temperature at which press molding is possible, the pressing rod 7 is pushed against the mold 11 to press it. Thus, an optical element is molded. After a molded article 13 is molded through pressing over a given time period, the cylinder 5 is lowered and returned to the position shown in (A) of FIG. 1. The shutter 33 is opened and the mold 11 is conveyed to the adjoining chamber.

After the mold 11 is placed in a given position in the cooling chamber 24, the cylinder 5 is elevated to bring the mold 11 near to or into contact with the upper radiating plate 4a and cool the mold 11 to a suitable temperature at which the quality of the molded article 13 becomes stable, i.e., a temperature around the Tg. Incidentally, the cooling may be natural cooling. After completion of the cooling step, the cylinder 5 is lowered to return the mold 11 to the position shown in (A) of FIG. 1. The shutter 34 is opened and the mold 11 is conveyed to the outside of the chamber 10.

The time period required for each of those steps, pressures of the cylinders 5, temperatures of the chambers, etc. are regulated as parameters in molding conditions to thereby mold a molded article having desired performances. For example, the time periods required for the respective steps are made equal and one mold 11 is disposed in each chamber so that these molds are simultaneously conveyed, whereby productivity is improved. Furthermore, when the apparatus is constituted so that two or more molds 11 can be placed in every chamber, the productivity may be further improved.

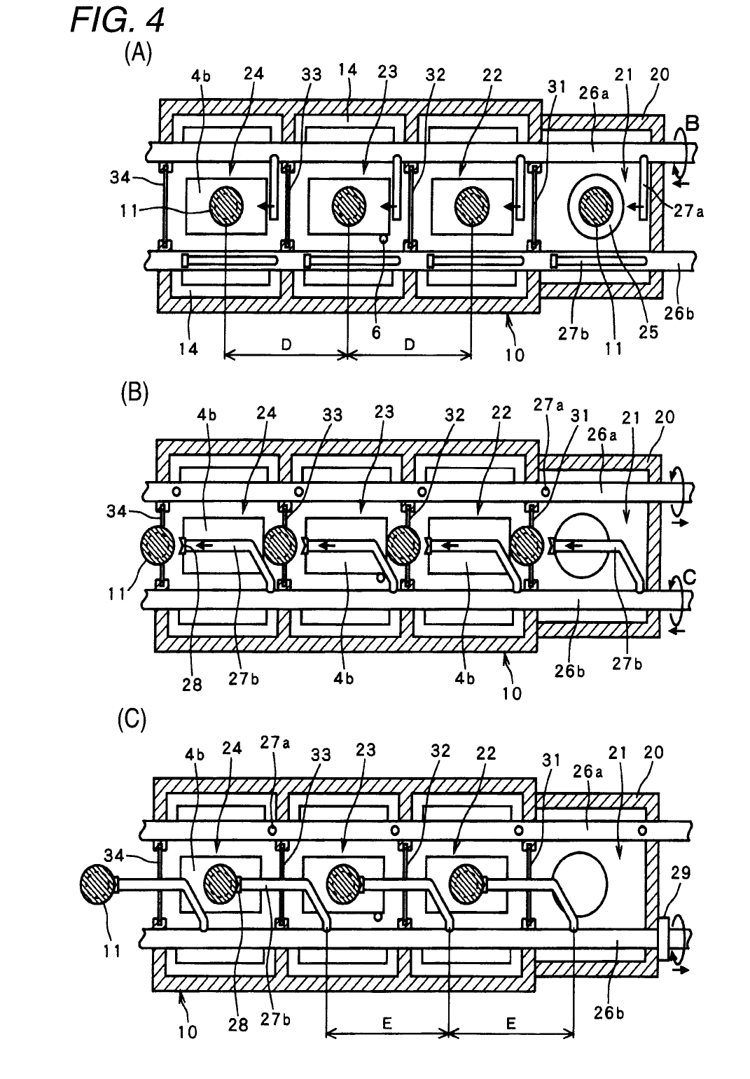

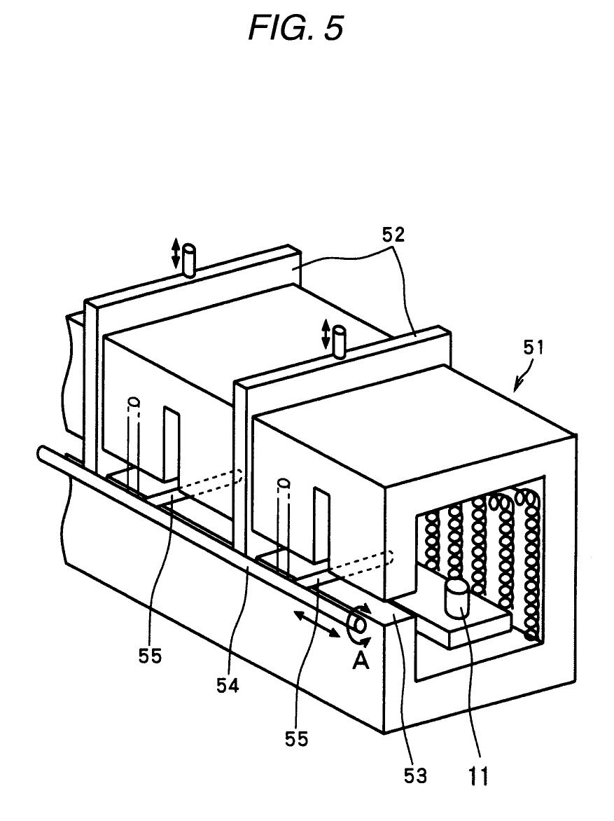

FIG. 4 contains plan views showing a method of conveying molds 11. All the molds 11 in the chamber 10 are simultaneously conveyed.

Two parallel conveying rods 26a and 26b are disposed on the left and right sides of molds 11 in parallel to the right-to-left conveyance direction in the figure. The conveying rods 26a and 26b respectively have conveying arms 27a and 27b, and are freely rotatable and are slidably movable forward and backward along the conveyance direction. Two conveying rods may be disposed on either of the left and right sides of the molds 11. However, from the standpoint of symmetry of the apparatus, it is preferred to dispose one on each of the left and right sides. Incidentally, the sliding parts of the conveying rods 26a and 26b are prevented from forming a gap during conveyance by applying a sealing material or the like thereto to thereby prevent oxygen from flowing into the chamber 10. The movement of the conveying rods 26a and 26b, movement of the shutters 31, 32, 33, and 34 and cylinders 5 in FIG. 1 described above, temperatures of the chambers, etc. are controlled by a control unit not shown in the figure.

After a mold 11 is disposed in the preliminary chamber 21, the mold 11 is conveyed with the conveying rods 26a and 26b. As described above, the conveyance of the mold 11 is conducted when the mold 11 is in the position shown in (A) of FIG. 1, i.e., in the state in which the cylinders 5 have been lowered until the level of the mold placement surface 25 of the preliminary chamber 21 becomes the same as that of the upper surface of the lower radiating plate 4b in the adjoining heating chamber 22.

For conveyance, the conveying rod 26a, which is located on the upper side in the figure, first rotates in the direction of arrow B so that the conveying arm 27a comes to lie horizontally and parallel to the mold placement surface 25 as shown in (A) of FIG. 4. The shutters 31, 32, 33, and 34 between the chambers are opened, upon which the conveying rod 26a moves slidably in the conveyance direction and the conveying arm 27a pushes and moves the mold 11. The conveying arm 27a moves the mold 11 to around the boundary between the chamber 21 and the adjoining chamber.

Thereafter, as shown in (B) of FIG. 4, the conveying rod 26a, which is located on the upper side, rotates in the direction opposite to that in (A) of FIG. 4 to set the conveying arm 27a upright and, simultaneously therewith, moves slidably in the direction opposite to the conveyance direction to return the conveying arm 27a to the original position. During this operation, the conveying rod 26b, which is located on the lower side, rotates in the direction of arrow C shown in (B) of FIG. 4 so that the conveying arm 27b comes to lie horizontally and parallel to the mold placement surface 25. The conveying rod 26b moves slidably in the conveyance direction and the conveying arm 27b pushes and moves the mold 11 to the position where the next step is conducted, as shown in (C) of FIG. 4. The conveying arm 27b is equipped at its tip with a positioner 28 for the mold 11. Since the positioner 28 regulates the position of the mold 11, the mold 11 can be conveyed so as to be placed in a correct position. Furthermore, the conveying rod 26b has a stopper 29 so that by slidably moving the rod 26b until the stopper 29 comes into contact with the outer surface of the wall 20 of the chamber 10, the mold 11 can be conveyed to a given position. Thereafter, the conveying rod 26b moves slidably in the direction opposite to the conveyance direction and rotates in the direction opposite to that in (B) of FIG. 4 to return to the original position. The shutters 31, 32, 33, and 34 close. Thus, each mold 11 is conveyed to the next step by a distance corresponding to one chamber. By making the interval E between the conveying arms 27b equal to the interval D of molds 11 to be placed and providing the stopper 29, the molds 11 can be easily and efficiently conveyed to and disposed in given positions. Furthermore, due to the disposition of the two conveying rods 26a and 26b, which respectively have conveying arms 27a and 27b, the distance over which one conveying arm 27a or 27b moves can be shorter than the distance of each chamber in the forward/backward direction and, hence, there is no need of forming a gap for passing the conveying arms 27a and 27b in the partition walls between the chambers. The gas tightness of each chamber can be maintained. Consequently, the oxygen concentration in the molding chamber 23 is efficiently reduced with a small amount of a non-oxidizing gas and the oxygen concentration in each chamber is easy to regulate.

Incidentally, it was ascertained by the applicant that high-precision optical elements are obtained in high yield with a low non-oxidizing gas flow rate by practicing the embodiment.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2006-010671 filed on Jan. 19, 2006, and the contents thereof are incorporated herein by reference.

### INDUSTRIAL APPLICABILITY

The invention is applicable to a press-molding apparatus for molded-article production which includes the steps of heating, molding, and cooling.

1. A press-molding apparatus comprising, disposed on a conveying passageway: a heating chamber for heating a mold containing a raw material placed therein; a molding chamber for press-molding the raw material in a non-oxidizing gas atmosphere; and a cooling chamber for cooling the mold after the molding, the mold being conveyed on the conveying passageway in order,
each of the heating chamber, the molding chamber, and the cooling chamber being blocked from the atmosphere upon the press-molding,
the press-molding apparatus comprising:
a means for blocking the molding chamber and the cooling chamber; and
an inflow port for introducing the non-oxidizing gas into the press-molding apparatus, the inflow port being formed for at least one of the heating chamber and the molding chamber.

2. The press-molding apparatus according to claim 1,
which has a means for blocking the heating chamber and the molding chamber, and the non-oxidizing gas inflow port is formed for the molding chamber.

3. The press-molding apparatus according to claim 1,
wherein the cooling chamber is blocked from the atmosphere with an opening/closing device attaining high gas tightness.

4. The press-molding apparatus according to claim 1,
wherein the means for blocking the molding chamber and the cooling chamber comprises either of; an opening/closing device capable of regulating gas tightness; and a partition wall having a hole whose degree of opening can be regulated.

5. The press-molding apparatus according to claim 2,
wherein the means for blocking the heating chamber and the molding chamber comprises either of: an opening/closing device capable of regulating gas tightness; and a partition wall having a hole whose degree of opening can be regulated.

6. The press-molding apparatus according to claim 1,
wherein the non-oxidizing gas is introduced through the inflow port after having passed through a dust collection filter of 50 μm or finer.

7. The press-molding apparatus according to claim 1,
wherein the non-oxidizing gas is introduced through the inflow port after having been heated to 50° C. or higher.
